(19) United States
(12) Patent Application Publication
(10) Pub. No.: US 2020/0379949 A1
(43) Pub. Date: Dec. 3, 2020

(54) MODIFICATION AND PERIODIC CURATION OF METADATA COLLECTED FROM A FILE SYSTEM

(71) Applicant: EMC IP Holding Company LLC, Hopkinton, MA (US)

(72) Inventor: Jan Ralf Alexander Olderdissen, Herrenberg (DE)

(21) Appl. No.: 16/429,327

(22) Filed: Jun. 3, 2019

(51) Int. Cl. G06F 16/16; G06F 16/14; G06F 16/901; G06F 16/907

(52) U.S. Cl. CPC G06F 16/162; G06F 16/907; G06F 16/9027; G06F 16/148

(57) ABSTRACT

The described technology is generally directed towards reducing the amount of data stored in a sequence of data blocks by combining deduplication and compression. According to an embodiment, a system can comprise a memory that can store computer executable components, and a processor that can execute the components stored in the memory. The components can comprise a receiver component to receive metadata describing directories in a data store, wherein the metadata comprises, for the respective ones of the directories, a descendant directory. The system can further comprise a data structure component to create a tree data structure, comprising nodes corresponding to the directories, and comprising links corresponding to the metadata of the respective ones of the directories. Further, the system, can comprise a curation component to cull non-useful portions of the metadata from the tree data structure periodically.

### TECHNICAL FIELD

The subject application generally relates to data storage, and, for example, managing data storage system, and related embodiments.

### BACKGROUND

Data assets in the form of unstructured data continue to challenge companies who struggle to manage their expanding requirements. Some industries routinely utilize large amounts of data that can be frequently copied, moved, and retained, usually through irregular processes. Common storage issues for these types of industries can include a difficulty in finding digital assets in a timely manner in deep directory structures, over distributed storage platforms. Other problems can occur when disorganized storage systems are filled to capacity. The disorganization in these systems can prevent capacity from being reclaimed by being archived or deleted.

Different approaches to these issues include expanding storage system size with new equipment, instead of attempting to solve organizational problems. Other approaches include disrupting workflows and restricting functions available to users, e.g., creating, modifying, and duplicating data.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

According to an embodiment, a system can comprise a memory that stores computer executable components and a processor that can execute the computer executable components stored in the memory. The computer executable components can comprise a receiver component to receive metadata describing respective ones of directories in a data store, wherein the metadata comprises, for the respective ones of the directories, a descendant directory. The system can further comprise a data structure component to create a tree data structure, based on the metadata, comprising nodes corresponding to the respective ones of the directories, and wherein the nodes comprise links corresponding to the metadata of the respective ones of the directories. Further, the system, can comprise a curation component to periodically cull non-useful portions of the metadata from the tree data structure.

According to another embodiment, a computer-implemented method can comprise receiving, by a first device comprising a processor, from a second device, a sequence of elements, wherein respective ones of the sequence of elements comprise blocks of data. The method can further comprise communicating, by a file system implemented using a processor, metadata describing respective ones of directories in the file system, wherein the metadata comprises, for the respective ones of the directories, a descendant directory. The method can further comprise retrieving, by the file system, a file from a directory of the directories of the file system, the retrieving being based on a data structure created, based on the metadata, comprising nodes corresponding to the respective ones of the directories in the file system, and wherein the nodes comprise links corresponding to the descendant directory of the respective ones of the directories of the file system. Further, the method can comprise deleting, by the file system, a branch of directories of the file system, the deleting being based on the data structure, wherein metadata corresponding to the branch of directories is rendered non-useful in the data structure, resulting in non-useful metadata in the data structure, and wherein a curating process periodically removes the non-useful metadata from the data structure.

According to another embodiment, a computer program product is provided. The computer program product can comprise machine-readable storage medium comprising executable instructions that, when executed by a processor, can facilitate performance of operations comprising receiving metadata describing respective ones of directories in a data store, wherein the metadata comprises, for the respective ones of the directories, a descendant directory. The operations can further comprise creating a tree data structure, based on the metadata, comprising nodes corresponding to the respective ones of the directories, and wherein the nodes comprise links corresponding to the metadata of the respective ones of the directories. Further, the method can comprise culling non-useful portions of the metadata from the tree data structure.

### BRIEF DESCRIPTION OF THE DRAWINGS

The technology described herein is illustrated by way of example and not limited in the accompanying figures in which like reference numerals indicate similar elements, and in which:

FIG. 1 illustrates a block diagram of an example, non-limiting system that can facilitate modification and periodic curation of metadata collected from a file system, in accordance with various aspects and implementations of the subject disclosure.

FIG. 2 illustrates a non-limiting example of a scanner component that can collect metadata describing a file system, in accordance with one or more embodiments described herein.

FIG. 3 illustrates an example node branch deletion function that can be performed by modifying a metadata structure, in accordance with one or more embodiments described herein.

FIG. 4 illustrates a non-limiting example of a curation process whereby records in the metadata structure database that are no longer being used, are periodically curated out of the database, in accordance with one or more embodiments described herein.

FIG. 5-6 illustrate an example of the curation process described above, where multiple tables are used to store elements of the tree data structure, in accordance with one or more embodiments described herein.

FIG. 7 illustrates an example flow diagram for a method that can facilitate modification and periodic curation of metadata collected from a file system, in accordance with one or more embodiments.

FIG. 8 is a flow diagram representing example operations of system comprising receiver component 122, data structure component 124, and curation component 125, in accordance with one or more embodiments.

FIG. 9 depicts an example schematic block diagram of a computing environment with which the disclosed subject matter can interact, in accordance with one or more embodiments.

FIG. 10 illustrates an example block diagram of a computing system operable to execute the disclosed systems and methods in accordance with various aspects and implementations of the subject disclosure.

### DETAILED DESCRIPTION

Various aspects described herein are generally directed towards facilitating modification and periodic curation of metadata collected from a file system, in accordance with one or more embodiments. As will be understood, the implementation(s) described herein are non-limiting examples, and variations to the technology can be implemented.

Reference throughout this specification to “one embodiment,” “one or more embodiments,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations.

The computer processing systems, computer-implemented methods, apparatus and/or computer program products described herein employ hardware and/or software to solve problems that are highly technical in nature (e.g., periodically curating potentially massive unstructured data repositories), that are not abstract and cannot be performed as a set of mental acts by a human. For example, a human, or even a plurality of humans, cannot efficiently modify and periodically curate complex, unstructured data systems (e.g., potentially containing petabytes of data and millions of files), with the same level of accuracy and/or efficiency as the various embodiments described herein. It should further be noted that, one or more embodiments can be implemented with features that can improve processing of massive data systems.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

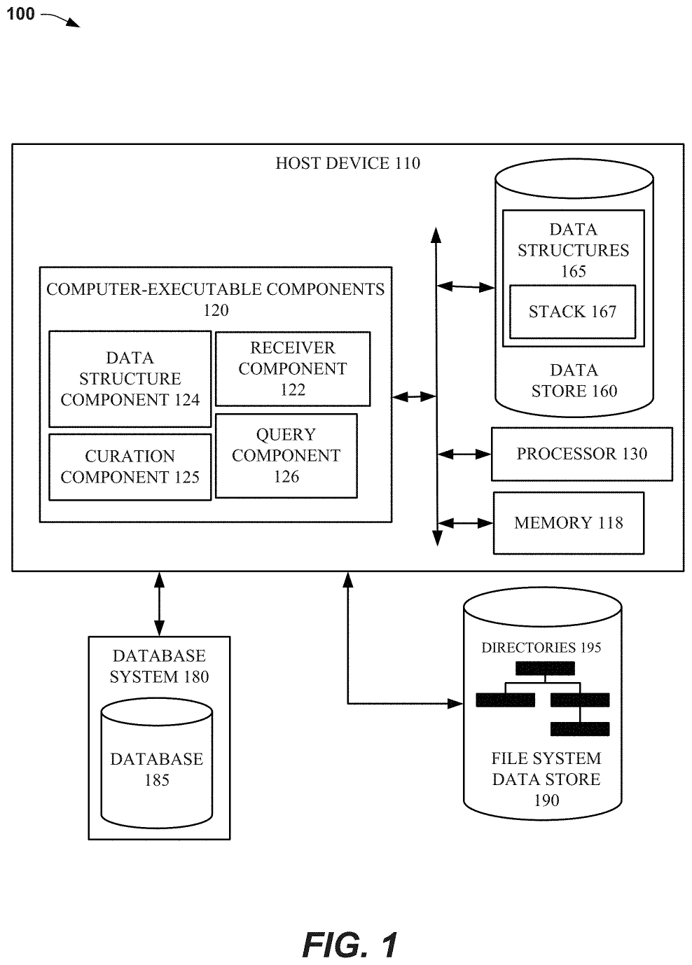

FIG. 1 illustrates a block diagram of an example, non-limiting system 100 that can facilitate modification and periodic curation of metadata collected from a file system, in accordance with various aspects and implementations of the subject disclosure.

Host device 110 can be coupled to database system 180, and file system data store 190. In one or more embodiments host device 110 can collect metadata from file system data store 190, e.g., metadata describing the structure and contents of directories 195. Once collected, or more embodiments can process and store the metadata as structured data, e.g., in database 185 of database system 180. In addition to the use of database 185 to store the collected metadata, one or more embodiments can use data store 160 to facilitate different functions described herein. For example, data store 160 can store data structures 165 that can be used during the modification and curation of metadata, e.g., stack 167.

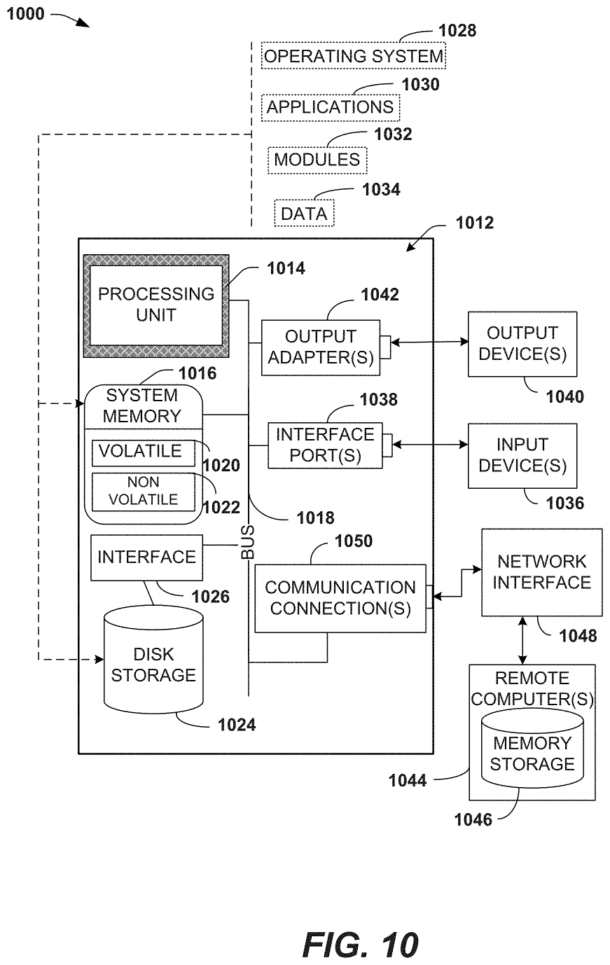

As discussed further below with FIG. 10, in some embodiments, memory 118 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 118 are described below with reference to system memory 1016 and FIG. 10. Such examples of memory 118 can be employed to implement any embodiments of the subject disclosure.

In some embodiments, processor 130 can comprise one or more of a central processing unit, multi-core processor, microprocessor, dual microprocessors, microcontroller, System on a Chip (SOC), array processor, vector processor, and/or another type of processor. According to multiple embodiments, processor 130 can implement one or more computer and/or machine readable, writable, and/or executable components and/or instructions that can be stored on memory 118. For example, processor 130 can perform various operations that can be specified by such computer and/or machine readable, writable, and/or executable components and/or instructions including, but not limited to, logic, control, input/output (I/O), arithmetic, and/or the like. Further examples of processor 130 are described below with reference to processing unit 1014 and FIG. 10. Such examples can be employed with any embodiments of the subject disclosure.

In one or more embodiments, in an example approach to performing the operations above, processor 130 can execute computer-executable components 120, including, but not limited to, data structure component 124, curation component 125, receiver component 122, and query component 126.

In one or more embodiments, host device 110 can be used to implement systems that are specifically designed to efficiently manage large, unstructured data systems, e.g., CLARITYNOW provided by DELL EMC. Moreover, example system that include file system data store 190 functions, that can be used with one or more embodiments, include primary storage and archive platforms, e.g., ISILON® NETWORK ATTACHED STORAGE (NAS) and ECS® NATIVE OBJECT ARCHIVE provided by DELL EMC.

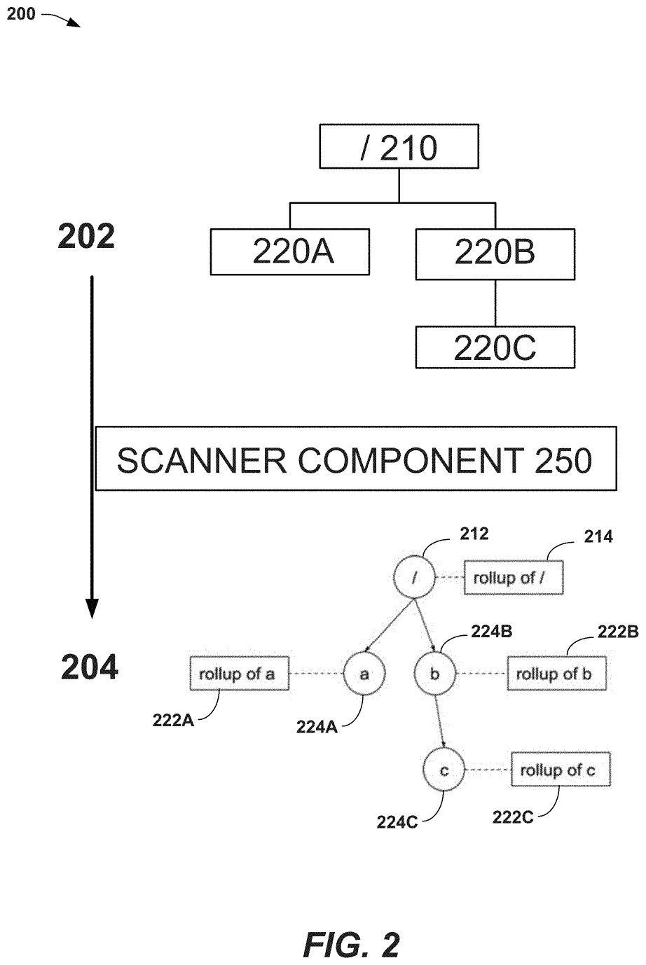

FIG. 2 illustrates a non-limiting example of a scanner component that can collect metadata describing file system 202, in accordance with one or more embodiments described herein. Repetitive description of like elements and/or processes employed in respective embodiments is omitted for sake of brevity.

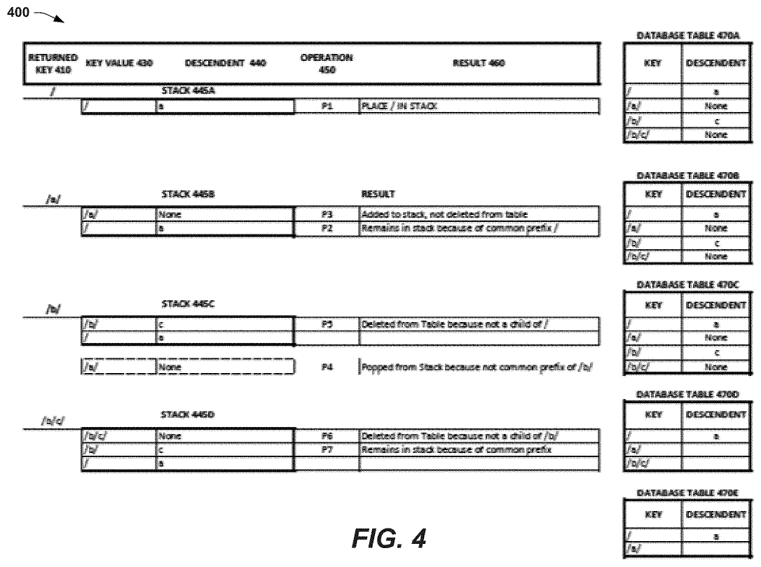

As used herein, file system 202 can contain files and have directories in a hierarchical structure, e.g., directories having a descendant directory (also termed a subdirectory). One or more embodiments can employ a scanner component 250 to read the directory structure and contents of the directories and generate metadata structure 204, e.g., stored as structured data in database 185. Example tables that can be used to store metadata structure 204 are included with the discussion of FIG. 4 below.

As depicted, scanner component 250 can detect root (/) directory 210 having subdirectories 220A and 220B, with subdirectory 220B having a subdirectory 220C. Based respectively on this example structure, root (/) node 212 can have descendent nodes 225A and 224B, with descendent nodes 224B having descendent node 224C. In one or more embodiments, nodes 224A-C can have properties that describe the structure of the nodes and the contents of the nodes.

Example properties of nodes 224A-C can include the descendants of a node (e.g., a record for node 224B can include “/c”) and the file contents of the directory corresponding to the node, e.g., a record for node 224B can include file1.txt, because this file is stored in subdirectory 220B. Further examples of database schemas that can support different embodiments are discussed below with FIG. 4.

An example database structure can have one record per node, with a key field corresponding to the path of the directory that corresponds to the node, e.g., a record for node 224C can have “/b/c” as a key field. In the discussion of curation with FIG. 4 below, different processes are described that are associated with the structure of this key field. Additional fields in the node records can include rollup information, e.g., information that, because it is easily available, can improve the performance of different operations, e.g., aggregate information that can be time consuming to determine upon request.

Example information that can be “rolled up” to improve different functions can include the aggregate size of files in a directory referenced by the node, as well as the descendants of the node, e.g., when subdirectory 220B contains 200 GB of files, and subdirectory 220C contains 300 GB of files, a value corresponding the total (e.g., 500 GB) can be rolled up and stored in node 224B for use upon a request for the total, e.g., without time-consuming calculation. Additional properties of directories that can be similarly rolled up include, but are not limited to file count, folder count, and file type count. One having skill in the relevant arts, given the description herein, would appreciate additional properties that can be advantageously rolled up by one or more embodiments.

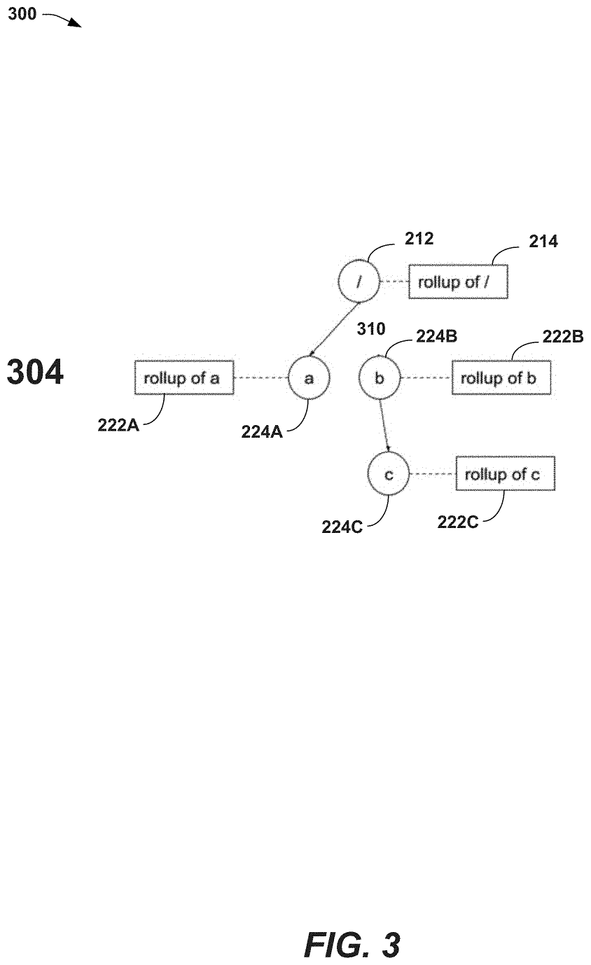

FIG. 3 illustrates an example node branch deletion function that can be performed by modifying metadata structure 204, in accordance with one or more embodiments described herein. Repetitive description of like elements and/or processes employed in respective embodiments is omitted for sake of brevity.

In an example depicted in FIG. 3, the node branch starting with node 224B (e.g., nodes 224B and 224C) can be deleted, for reasons that can include, but are not limited to, a need to almost instantly remove the files in file system 202 (e.g., filed in subdirectories 220B-C) from being searchable. When considering functions performed by one or more embodiments described herein, it should be noted that, some circumstances, a large amount of overhead can be associated with deleting entire node branches from a directory structure using the file system. This problem can be aggravated when the node branch has hundreds or thousands of nested directories, when the directories individually or collectively contain thousands of files, and when the aggregated contents of node branches are terabytes or petabytes in size.

Returning to the example of FIG. 3, as noted above, one of the rollup data fields, that can be stored in a record corresponding to a node, can be the descendent of the node, e.g., for the root (/) node 212, the subdirectory /b can be included in this field, referencing node 224B. In one or more embodiments, for searching a node branch (to search for a subdirectory or contents of a subdirectory) query component 126 can use these subdirectory fields to guide a search process to traverse the branch to perform the search.

Based on the above, to delete (e.g., remove from search results) the entire node branch below node 224B, one or more embodiments can modify the record in database 185 that corresponds to root (/) node 212 and remove one of the two entries for that record, e.g., the record includes/a, and/b as descendent nodes, removing/b from this field will effectively remove this node branch from being available to the system, at least when starting a search from the root (/) node 212.

To improve the deletion of the node branch for 224B, one or more additional embodiments can prohibit the commencement of a search from any node other than root (/) node 212. This feature can correct a potential problem whereby a node branch is intended to be deleted from the metadata store, and thus be unavailable, but can be successfully searched from a node, other than the root (/) node 212. For example, although a search that begins at root (/) node 212 would not return references to the node branch, a search that begins a search traversal at node 224B would still be successful, because the descendent node reference in node 224B remains in the record, e.g., /c still remains in the descendent field of the record for node 224B. To address this potential problem, instead of editing (e.g., removing the descendent node value) some or all the records of the node branch (e.g., 224B-C, and potentially thousands of additional descendent nodes), and incurring potentially substantial additional overhead, one or more embodiments can prevent search traversals from starting at any node other than the root (/) node 212.

FIG. 4 illustrates a non-limiting example of a curation process whereby records in the metadata structure database that are no longer being used, are periodically curated out of the database, in accordance with one or more embodiments described herein. Repetitive description of like elements and/or processes employed in respective embodiments is omitted for sake of brevity.

As noted above, to delete entire node branches from the system, one or more embodiments, only need to remove a descendent value from an immediate ancestor node, and search traversals cannot find the node branch. With this process however, the small changes that enable rapid execution of the function (e.g., changing one field of one record), can also, in some circumstances cause large numbers of inactive records to remain in database 185. For example, the records for nodes 224B-C are no longer available for searching, but remain in the system, after the initial deletion step.

To address this potential problem, while maintaining the high-performance of the deletion action discussed above, one or more embodiments can render the records unnecessary by removing a descendent reference to the first record, then, on a deferred basis, execute a curation component that traverses the branches of the metadata structure and removes unnecessary records. The deferral of the curation process can be implemented by having the process execute after a particular interval, and also causing the process to run at an off-peak time of day for the system, e.g., running asynchronously, as a batch job.

Considering the example of FIG. 4, it should be noted that the state of the system is one after the node branch under node 224B has been deleted, e.g., the descendent node reference to node 224B was removed. One activity to be performed by curation component 125 can be the removal of the records in database 185 that correspond to nodes 224B-C. One non-limiting, example approach to performing this curation function is described in detail below, with reference to the tables of FIG. 4.

Database objects 470A-E represent the same database object, with contents changing after each step. Note that database object 470A is the current state of the object (e.g., the root (/) key record has no descendent reference to /b/) and database object 470F is the result of the curation process as described above, e.g., the inactive records for /b/ and /c/ are removed. One way to accomplish this curation result is for one or more embodiments to use stack 445A-D and this example shows the contents of the example stack after each stage of the curation process.

An example curation process can commence with an iterator process being kicked off which can receive, from database 185, a sorted list of the keys in database object 470A, e.g., /, /a/, /b/, /b/c/. Next the iterator can, in order, select each key for processing. One having skill in the relevant arts, given the description herein, will appreciate that one advantage to iterating one key at a time as opposed to changing the object all at once, can accrue from a reduction in database locking required for the process.

As depicted in FIG. 4, the first returned key 410 “/” is selected and, at operation 450 P1, placed in stack 445A. It should be noted that, in this example, both key value 430 “/” and associated descendent 440 “a” from database object 470A are added to the stack. Because this is the first value added to stack 445A, no comparison between returned key 410 “/” and the top item of stack 445A is performed. This comparison is described with the other returned keys 410 discussed below.

One or more embodiments of iterator return the next key in the sorted list: “/a/”. Before being placing in stack 445B, the new returned key 410 is compared to the top entry in stack 445B, to determine whether both key values share a common prefix (or ancestor). If the key values do not have a common prefix then the top entry in stack 445B is popped from stack 445B and replaced by the new key entry 410. In one or more embodiments, this process can be repeated until the incoming path and the stack have a common prefix, e.g., which can be /.

In this example, key entry 410 “/a/” is compared with “/” and, because they share a common prefix (“/”), at operation P2, the “/” entry remains in the stack. Next, at operation P3, returned key 410 is pushed onto the stack 445B, and the descendent 440 value of the previous top entry of the stack 445B (“/”) is checked to determine whether the returned key 410 value “/a/” is listed as a descendent. Because “/a/” is included in the record for “/” as a descendent, /a/ is not deleted from database object 470B. It should be noted that, at this stage, database object 470B has not been changed.

The next key value returned from the sorted key list is “/b/”. As described above, this key value is compared to the top entry of the stack (“/a/”) to test whether the nodes share the same prefix. At operation P4, because these two keys do not share a common prefix, the “/a/” entry is popped from the stack and replaced by the “/b/” entry. Next, one or more embodiments can determine whether the previous entry in the stack (“/”) lists “/b/” as a descendent. It should be noted that it was the removal of this “/b” value from the root “/” node that deleted the branch and rendered the “/b” and “/b/c” nodes non-useful. Thus, at operation P5 the non-useful “/b” record is removed from database object 470C. Based on this deletion of the “/b” record as non-useful, an additional operation can be performed with reference to the “/b” entry in stack 445C. In one or more embodiments, because “/b” is deleted from database object 470C, the descendent value stored in the stack with the “/b” entry is cleared, e.g., so that any descendants of “/b” can also be removed from the tree data structure.

A process similar to the process described with “/b” above can occur when the next returned key 410 “/b/c” is processed. As shown, the previous entry (“/b”) remains in the stack because “/b/c” share the same prefix, and, because “/c” is not listed as a descendent of “/b” (e.g., it was removed in the previous operation), the “/b/c” record can be deleted from database object 470D, thus completing the removal of the non-useful records in database object 470A, by one or more embodiments.

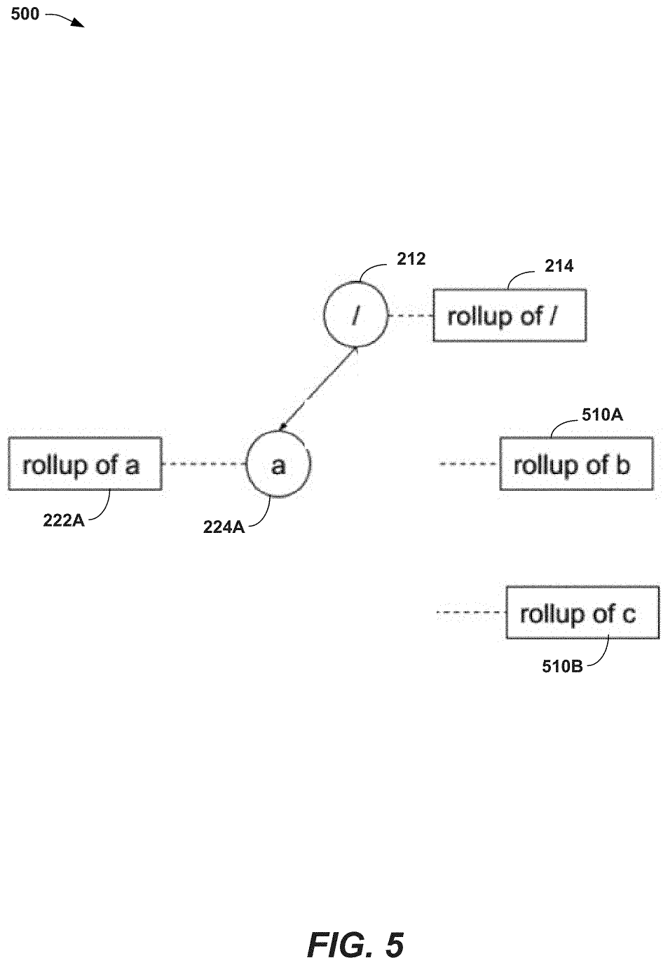

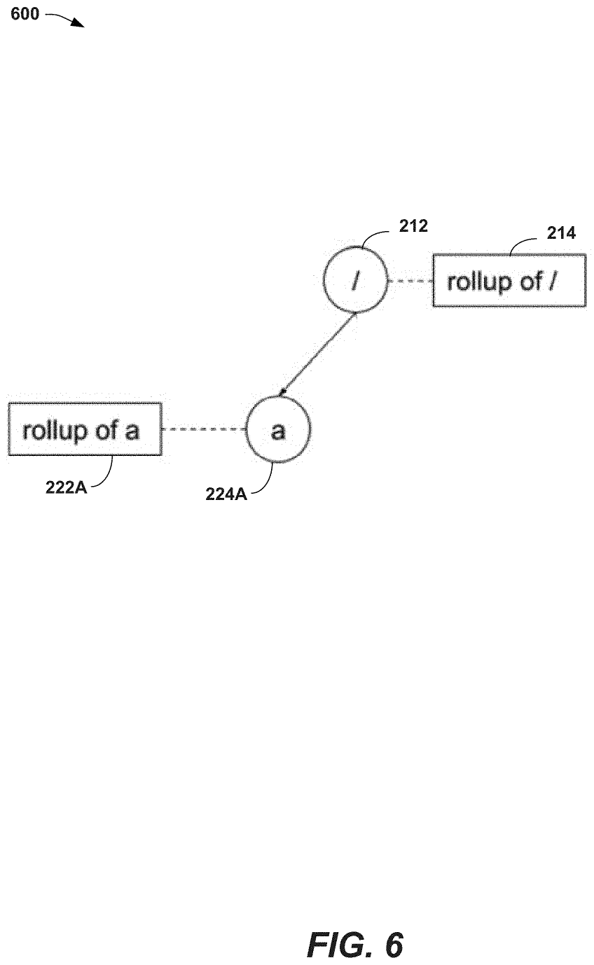

FIG. 5-6 illustrate an example of the curation process described above, where multiple tables are used to store elements of the tree data structure, in accordance with one or more embodiments described herein. Repetitive description of like elements and/or processes employed in respective embodiments is omitted for sake of brevity.

As noted above, the tree data structure that comprises the metadata structure 204 can be implemented using database 185. In one or more embodiments, this database 185 can be a relational database, e.g., with multiple tables linked by key values. In one or more embodiments, one or more of the fields of the node record can be stored in a different object, and linked up to a main object, using relational database concepts. For example, database object 470A can, in one or more embodiments include an additional field to store the contents of the folder of the nodes, e.g., the “/a/” row can have an additional column for contents that contains “file1.txt”.

In an alternative implementation, instead of an additional column in database object 470A, an additional database object can be used to link the contents value to the database object 470A, e.g., the new object containing a row: “/a/,” “file1.txt”. In one or more embodiments, this approach can be used, in some circumstances, to reduce database object locking issues. This additional source of data for nodes 224B-C is depicted in FIG. 5 by rollup data 510A-B, respectively referencing nodes 224B-C removed in the curation process described above.

It should be noted that, with this multi-object implementation, the curation process described with FIG. 4 above would only remove non-useful database records from one of the two tables, e.g., the second object would also have non-useful records, and these would remain. To address this issue, in one or more embodiments, additional tables used in the tree data structure can also be traversed using the curation approach described with FIG. 4 above. One way to facilitate this process being used for the additional tables is to also include the descendent field with the records of the second object. Thus, the row in the new object would also include a column to include descendants of the node. FIG. 6 depicts a version of the tree data structure after the curation process has been executed for all database tables that implement the tree data structure.

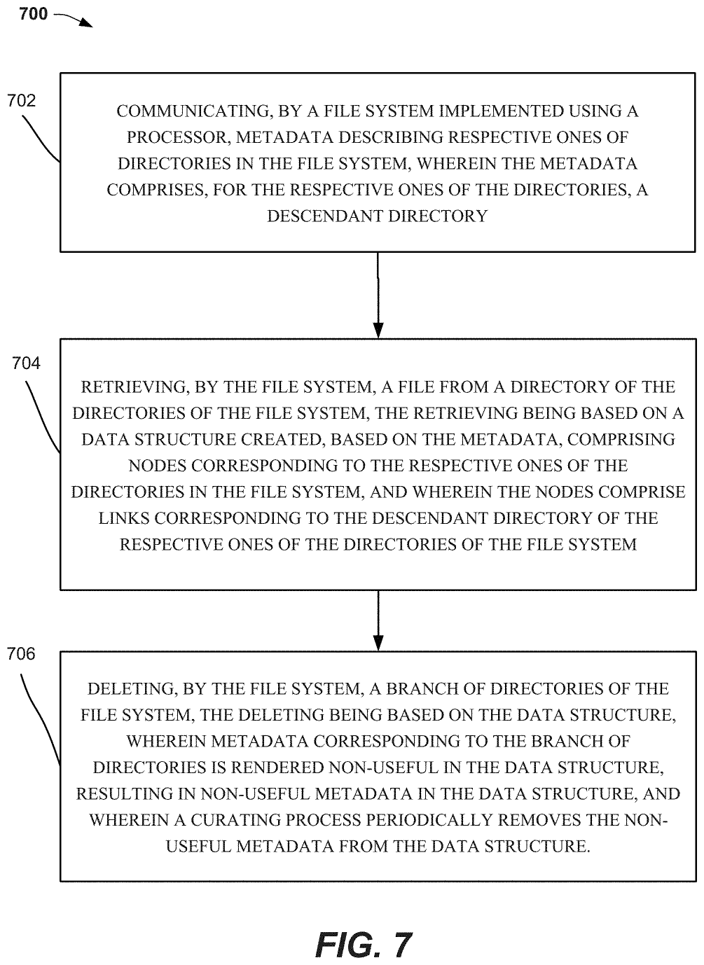

FIG. 7 illustrates an example flow diagram for a method 700 that can facilitate modification and periodic curation of metadata collected from a file system, in accordance with one or more embodiments. For purposes of brevity, description of like elements and/or processes employed in other embodiments is omitted.

At element 702, method 700 can comprise communicating, by a file system (e.g., file system data store 190) implemented using a processor 130, metadata describing respective ones of directories 195 in the file system (e.g., file system data store 190), wherein the metadata comprises, for the respective ones of the directories 195, a descendant directory, e.g., subdirectory 220C is a descendent directory of directory 220B.

At element 704, method 700 can comprise retrieving, by the file system (e.g., file system data store 190), a file (e.g., file1.txt discussed with FIG. 4) from a directory (e.g., directory 220B) of the directories of the file system, the retrieving being based on a data structure (e.g., metadata structure 204 is a tree data structure) created, based on the metadata, comprising nodes 224A-C corresponding to the respective ones of the directories in the file system, and wherein the nodes 224A-C comprise links corresponding to the descendant directory of the respective ones of the directories of the file system.

At element 706, method 700 can comprise deleting (e.g., discussed with FIG. 3 above), by the file system, a branch of directories of the file system, the deleting being based on the data structure, wherein metadata corresponding to the branch of directories is rendered non-useful in the data structure, resulting in non-useful metadata in the data structure, and wherein a curating process periodically removes the non-useful metadata from the data structure, e.g., discussed with FIG. 4 above.

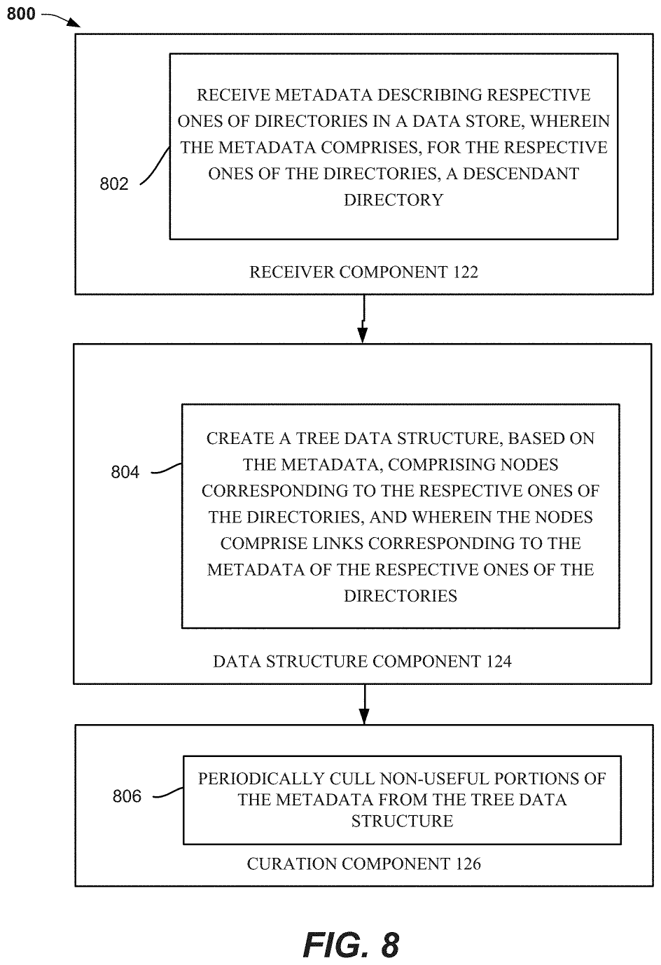

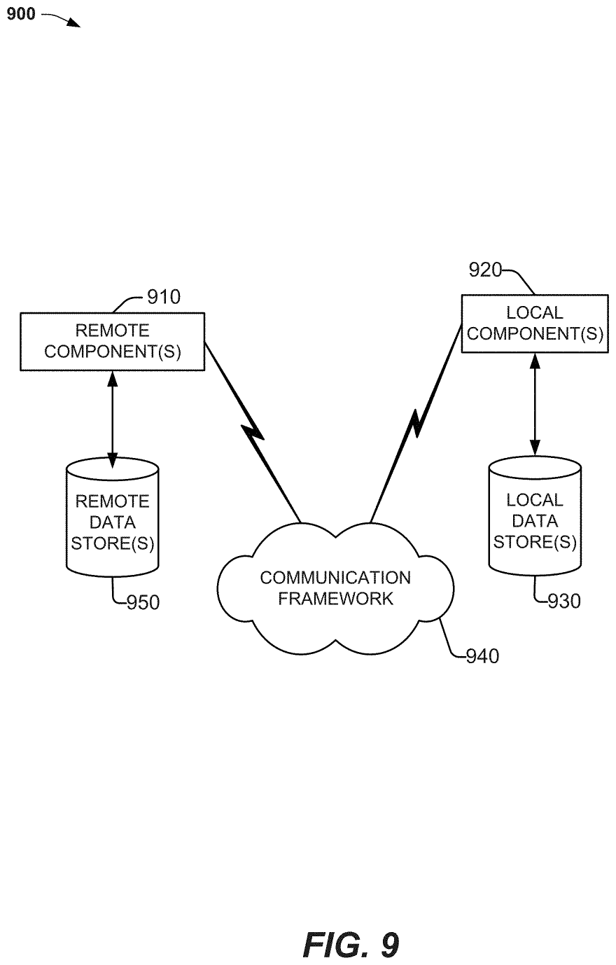

FIG. 8 is a flow diagram representing example operations of system comprising receiver component 122, data structure component 124, and curation component 125, in accordance with one or more embodiments. For purposes of brevity, description of like elements and/or processes employed in other embodiments is omitted.

Receiver component 122 can be configured to receive metadata describing respective ones of directories in a data store, wherein the metadata comprises, for the respective ones of the directories, a descendant directory.

Data structure component 124 can be configured to create a tree data structure, based on the metadata, comprising nodes corresponding to the respective ones of the directories, and wherein the nodes comprise links corresponding to the metadata of the respective ones of the directories. Curation component 125 can be configured to periodically cull non-useful portions of the metadata from the tree data structure.

The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, FIG. 8, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with one or more embodiments/implementations described herein. Computer 1012 can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1394), and small computer systems interface.

System memory 1016 can comprise volatile memory 1020 and non-volatile memory 1022. A basic input/output system, containing routines to transfer information between elements within computer 1012, such as during start-up, can be stored in non-volatile memory 1022. By way of illustration, and not limitation, non-volatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, can cause a system comprising a processor to perform operations, comprising determining a mapped cluster schema, altering the mapped cluster schema until a rule is satisfied, allocating storage space according to the mapped cluster schema, and enabling a data operation corresponding to the allocated storage space, as disclosed herein.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in a suitable operating environment, e.g., computing system 1000. Such software comprises an operating system 1028. Operating system 1028, which can be stored on disk storage 1024, acts to control and allocate resources of computer 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command line controlled interface, etc., allowing a user to interact with computer 1012. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial bus port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to system bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the invention is susceptible to various modifications and alternative constructions, certain illustrated implementations thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the invention is not to be limited to any single implementation, but rather is to be construed in breadth, spirit and scope in accordance with the appended claims.

What is claimed is:

1. A system, comprising:
a memory that stores computer executable components; and
a processor that executes the computer executable components stored in the memory, wherein the computer executable components comprise:
a receiver component to receive metadata describing respective ones of directories in a data store, wherein the metadata comprises, for the respective ones of the directories, at least one descendant directory;
a data structure component to create a tree data structure, based on the metadata, comprising nodes corresponding to the respective ones of the directories, and wherein the nodes comprise links corresponding to the metadata of the respective ones of the directories; and
a curation component to cull non-useful portions of the metadata from the tree data structure periodically.

2. The system of claim 1, wherein the computer executable components further comprise a query component to read the metadata to traverse the tree data structure and return results based on a query.

3. The system of claim 2, wherein the query component is prevented from traversing the tree data structure starting from any node other than a root node of the tree data structure.

4. The system of claim 1, wherein the non-useful portions of the metadata are rendered non-useful based on a deleting a branch of the nodes from the tree data structure.

5. The system of claim 4, wherein the deleting the branch of the nodes from the tree data structure is based on a modification of a node comprised in the tree data structure.

6. The system of claim 5, wherein the modification of the node comprises modifying a value corresponding to the descendant directory of the node.

7. The system of claim 1, wherein the curation component culls the tree data structure by a process comprising:
traversing a branch of the tree data structure by employing a stack data structure based on the metadata comprised in respective ones of the nodes of the tree data structure, wherein traversed nodes of the tree data structure are processed by sequentially adding data corresponding to the traversed nodes to the stack data structure and removing the data corresponding to the traversed nodes that do not correspond to the branch of the tree data structure; and
processing the data corresponding to the traversed nodes remaining in the stack data structure by removing a non-useful node from the tree data structure, wherein the non-useful node is rendered non-useful based on a previous node in the stack data structure not referencing the non-useful node as a descendent node.

8. The system of claim 1, wherein the tree data structure created by the data structure component is created by employing records in a database system.

9. A method, comprising,
communicating, by a file system implemented using a processor, metadata describing respective ones of directories in the file system, wherein the metadata comprises, for the respective ones of the directories, a descendant directory;
retrieving, by the file system, a file from a directory of the directories of the file system, the retrieving being based on a data structure created, based on the metadata, comprising nodes corresponding to the respective ones of the directories in the file system, and wherein the nodes comprise links corresponding to the descendant directory of the respective ones of the directories of the file system; and
deleting, by the file system, a branch of directories of the file system, the deleting being based on the data structure, wherein metadata corresponding to the branch of directories is rendered non-useful in the data structure, resulting in non-useful metadata in the data structure, and wherein a curating process periodically removes the non-useful metadata from the data structure.

10. The method of claim 9, wherein the retrieving the file from the directory is further based on a query of the metadata of the data structure.

11. The method of claim 10, wherein the query of the metadata of the data structure is prevented from being used to traverse the data structure starting from any node other than a root node of the data structure.

12. The method of claim 9, wherein the metadata is rendered non-useful based on a deleting of a branch of the nodes from the data structure.

13. The method of claim 12, wherein the deleting the branch of the nodes from the data structure is based on a modification of a node comprised in the data structure.

14. The method of claim 13, wherein the modification of the node comprises modifying a value corresponding to the descendant directory of the node.

15. The method of claim 9, wherein the curating process comprises:
traversing a branch of the data structure by employing a stack data structure based on the metadata comprised in respective ones of the nodes of the data structure, wherein traversed nodes of the data structure are processed by sequentially adding data corresponding to the traversed nodes to the stack data structure and removing the data corresponding to the traversed nodes that do not correspond to the branch of the data structure; and
processing the data corresponding to the traversed nodes remaining in the stack data structure by removing a non-useful node from the data structure, wherein the non-useful node is rendered non-useful based on a previous node in the stack data structure not referencing the non-useful node as a descendent node.

16. The method of claim 9, wherein the data structure is created by employing records in a database system.

17. A machine-readable storage medium comprising executable instructions that, when executed by a processor, facilitate performance of operations, the operations comprising:
receiving metadata describing respective ones of directories in a data store, wherein the metadata comprises, for the respective ones of the directories, a descendant directory;
creating a tree data structure, based on the metadata, comprising nodes corresponding to the respective ones of the directories, and wherein the nodes comprise links corresponding to the metadata of the respective ones of the directories; and
culling non-useful portions of the metadata from the tree data structure.

18. The machine-readable storage medium of claim 17, wherein the operations further comprise querying the tree data structure by reading the metadata to traverse the tree data structure and return results based on a query.

19. The machine-readable storage medium of claim 18, wherein the querying the tree data structure is prevented from traversing the tree data structure starting from any node other than a root node of the data structure.

20. The machine-readable storage medium of claim 17, wherein the tree data structure is created by employing records in a database system.
